(19) United States
(12) Patent Application Publication
(10) Pub. No.: US 2009/0233137 A1
(43) Pub. Date: Sep. 17, 2009

(54) Cell unit for a fuel cell and method for manufacturing the same

(75) Inventors: Nathan E. Stott, Suwon-si (KR); Jae-Woo Joung, Suwon-si (KR); Jae-Hyuk Jang, Seoul (KR); Craig Miesse, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/382,424

(22) Filed: Mar. 16, 2009

(30) Foreign Application Priority Data
Mar. 17, 2008 (KR) 10-2008-0024519
Dec. 9, 2008 (KR) 10-2008-0124787

(51) Int. Cl. H01M 8/10; B05D 5/12

(52) U.S. Cl. 429/30; 427/115

(57) ABSTRACT

A cell unit for a fuel cell and a method for manufacturing the cell unit for a fuel cell are disclosed. The cell unit for a fuel cell can include an electrolyte membrane, an electrode unit that includes an anode formed on one side of the electrolyte membrane and a cathode formed on the other side of the electrolyte membrane, and a porous current collector formed by coating a conductive material onto the porous surfaces of the electrode unit.

With the present invention, it can be possible to reduce the contact resistance between the electrodes (the anode and the cathode), and their respective current collector, to thereby increase current collection efficiency and it can also be possible to make the thickness of the end plates thinner than a conventional design without sacrificing performance, to thereby decrease the overall size of a fuel cell.

### CROSS-REFERENCE TO RELATED APPLICATIONS

This application claims the benefit of Korean Patent Application No. 10-2008-0024519 and No. 10-2008-0124787 filed with the Korean Intellectual Property Office on Mar. 17, 2008, and Dec. 9, 2008, respectively, the disclosure of which is incorporated herein by reference in its entirety.

### BACKGROUND

1. Technical Field

The present invention relates to a cell unit for a fuel cell and to a method for manufacturing the cell unit for a fuel cell.

2. Description of the Related Art

Portable electronic devices are being provided in smaller sizes and with a greater variety of functions, and accordingly, there is currently a demand for higher efficiency and longer operation times in devices for supplying electrical power to such portable electronic devices. In this context, the fuel cell, which converts chemical energy directly into electrical energy, is gaining importance as a new alternative for radically increasing the efficiency and life expectancy of a portable power supply device.

According to the related art, current collectors are juxtaposed against an anode and a cathode of a membrane electrode assembly. The related art, however, causes electrical contact resistance between the current collector, and the anode and the cathode. Accordingly, it is required to use thick end plates in order to impart sufficient and uniform compression between the current collector, and the anode and the cathode to reduce these contact resistances. This contributes to the overall size of a fuel cell.

### SUMMARY

An aspect of the invention provides a cell unit for a fuel cell, and a method for manufacturing the cell unit for a fuel cell, in which the contact resistance is reduced between an anode and a cathode, and their respective current collector, so that the efficiency of current collection may be increased, and the size of a fuel cell may be decreased.

Another aspect of the invention provides a cell unit for a fuel cell that includes an electrolyte membrane, an electrode unit that includes an anode formed on one side of the electrolyte membrane and a cathode formed on the other side of the electrolyte membrane, a porous current collector, being formed by coating a conductive material onto the porous surfaces of the electrode unit.

In certain embodiments, the cell unit for a fuel cell can include multiple electrode units and can further include leads that electrically connect the multiple electrode units.

The lead may electrically connect the multiple electrode units in series.

Yet another aspect of the invention provides a method of manufacturing a cell unit for a fuel cell that includes forming an electrode unit on both surfaces of an electrolyte membrane by forming an anode on one surface of the electrolyte membrane and a cathode on the other surface of electrolyte membrane and forming a porous current collector by coating a conductive material onto the porous surfaces of the electrode unit.

The operation of forming the porous current collector can include coating a conductive material over the electrode unit by an inkjet method, and curing and sintering the conductive material.

Multiple electrode units can be formed on the electrolyte membrane, in which case the method can further include forming leads that electrically connect the multiple electrode units, after the operation of providing the electrolyte membrane.

Forming the leads can include coating a conductive material over the electrolyte membrane by an inkjet method, and curing and sintering the conductive material.

The operations for forming the porous current collector and forming the leads may be performed simultaneously.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a plan view of a cell unit for a fuel cell according to an embodiment of the invention.

FIG. 2 is a side view of a cell unit for a fuel cell according to an embodiment of the invention.

FIG. 3 is a flowchart illustrating a method of manufacturing a cell unit for a fuel cell according to an embodiment of the invention.

FIG. 4, FIG. 5, and FIG. 6 are plan views each representing a process in a method of manufacturing a cell unit for a fuel cell according to an embodiment of the invention.

FIG. 7, FIG. 8, and FIG. 9 are side views each representing a process in a method of manufacturing a cell unit for a fuel cell according to an embodiment of the invention.

### DETAILED DESCRIPTION

The cell unit for a fuel cell and method for manufacturing the cell unit for a fuel cell according to certain embodiments of the invention will be described below in more detail with reference to the accompanying drawings. Those components that are the same or are in correspondence are rendered the same reference numeral regardless of the figure number, and redundant explanations are omitted.

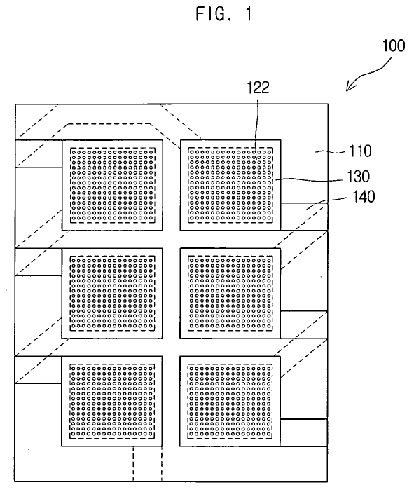

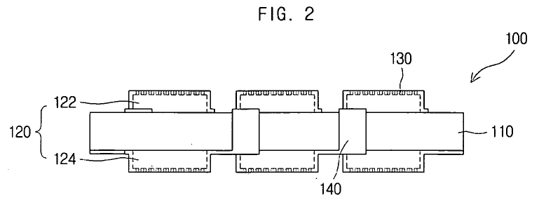

FIG. 1 is a plan view of a cell unit for a fuel cell according to an embodiment of the invention, and FIG. 2 is a side view of a cell unit for a fuel cell according to an embodiment of the invention. In FIGS. 1 and FIG. 2, there are illustrated a cell unit 100 for a fuel cell, an electrolyte membrane 110, electrode units 120, anodes 122, cathodes 124, porous current collectors 130, and leads 140.

This embodiment of the present invention suggests the cell unit 100 for a fuel cell that can reduce the contact resistance between the electrode unit 120 and the porous current collector 130 by coating a conductive material onto the porous surfaces of the electrode unit 120 formed to include the anode 122 and the cathode 124 in order to form the porous current collector 130 having micro-pores, thereby improving the efficiency of current collection for an identical area, in collecting electrons from the electrode unit 120.

The embodiment of the present invention also suggests the cell unit 100 for a fuel cell that can make the thickness of the end plates used for the fuel cell thinner with additional increases in current collection efficiency, to thereby minimize the volume of the fuel cell.

A multiple number of electrode units 120 can be electrically connected in series using leads 140 formed on the electrolyte membrane 110, so that it may not be necessary to use a separate flexible substrate, etc., for electrically connecting the electrode units 120. Thus, the cell unit 100 for a fuel cell may be produced with a simpler structure and utilized in electronic devices requiring higher voltages.

The electrolyte membrane 110 can be interposed between the anodes 122 and the cathodes 124, and can allow transport movement of the hydrogen ions generated by an oxidation reaction at the anodes 122 to the cathodes 124. A polymer material can be used for the electrolyte membrane 110.

The electrode unit 120 can include the anodes 122 and cathodes 124, where multiple electrode units 120 may be formed on the surface of the electrolyte membrane 110. The anodes 122 can be formed on one side of the electrolyte membrane 110, and can be supplied with fuel, such as hydrogen, which may undergo an oxidation reaction in the catalyst layers of the anodes 122 to generate hydrogen ions and electrons. The cathodes 124 can be formed on the other side of the electrolyte membrane 110, and can be supplied with oxygen, the electrons generated at the anodes 122 and the hydrogen ions transmitted via the electrolyte membrane 110 from the corresponding anode 122 and, which may undergo a reduction reaction at the catalyst layers of the cathodes 124 to generate water molecules.

Such oxidation and reduction reactions can be utilized to obtain electrical energy directly from chemical energy. The chemical reactions at the anodes 122 and cathodes 124 can be represented by the following Reaction Scheme 1.

[Reaction Scheme 1]

| | |
|---|---|
| Anode 122: | H₂ → 2H⁺ + 2e⁻ |
| Cathode 124: | O₂ + 4H⁺ + 4e⁻ → 2H₂O |
| Overall Reaction: | 2H₂ + O₂ → 2H₂O |

Since multiple electrode units 120 can be formed over both sides of the electrolyte membrane 110, electrically connecting the electrode units 120 in series can provide a high voltage without increasing the overall thickness as in the case of a bipolar stack structure.

Leads 140 can be used to electrically connect the electrode units 120 in series. This will be described later in further detail in the description of the leads 140.

The porous current collectors 130 can be formed by coating a conductive material onto the porous surfaces of the gas diffusion layers of the electrode unit 120, i.e. the anode 122 and the cathode 124.

As described above, electrons can be generated by the oxidation reaction at the catalyst layer of an anode 122. These electrons may pass through the gas diffusion layer of the anode 122 to gather at the porous current collector 130 and may travel through the lead 140 to the porous current collector 130 of a cathode 124, where they may pass through the gas diffusion layer of the cathode 124, where they may participate in the reduction reaction.

At this time, the contact resistance between the electrode unit 120 and the porous current collector 130 can be reduced by directly forming porous current collectors 130 onto the porous surfaces of the electrode unit 120. Accordingly, the required thickness of the endplates can be reduced, to thereby reduce the volume of the fuel cell.

The porous current collectors 130 can be formed by coating the surfaces of the electrode units 120 with a conductive material using an inkjet method, and then curing and sintering the conductive material. Here, the conductive material can be a material containing gold, and can include, for example, nanoparticles of 100 nanometers or smaller. Conductive carbon blacks are another example of conductive materials that may be used.

By applying a conductive material, for example, containing gold particles of 100 nanometers or smaller, thinly over the electrode units 120, it can be possible to coat the conductive material on pores of the electrode unit 120. Then the conductive material can be cured and sintered, for example, at a temperature of 100 to 1000 degrees Celsius. As a result, it can be possible to form the porous current collector 130 having micro-pores corresponding to the native pores of the porous surfaces, for example such as but not limited to those formed by the mesh structures of carbon cloth or woven carbon fibers, of the electrode unit 120.

As such, since the porous current collectors 130 are directly formed on the electrode unit 120 by using an inkjet method, the porous current collectors 130 can be made to adhere closely to and contact intimately with the electrode units 120, thereby reducing the contact resistance acting between the anodes 122 and cathodes 124, and the current collector layers 130 can be reduced in size. Accordingly current collection efficiency can be increased.

At this time, it may be required to control the amount of conductive material coated in order to adequately maintain the balance between the electric conductivity of the porous current collectors 130 and the flow fluidity of the electrode unit 120. In other words, the more amount of the conductive material that is being coated on the electrode unit 120 to form the porous current collectors 130 can cause the electric conductivity of the porous current collectors 130 to be increased to more effectively collect and conduct electrons but may simultaneously cause the pores of the porous surfaces of the electrode unit 120 to be narrower to constrict or block the flow of fuel or oxygen. Accordingly, it is necessary to adjust the amount of the conductive material that is being coated on the porous surfaces of the electrode unit 120 in order to optimize between the electric conductivity and the flow fluidity.

On the other hand, it may be required to adjust the hydrophile-lipophile balance (HLB) between the conductive material and the electrode unit 120 in order to prevent possible damage of the catalyst layer or the electrolyte membrane 110, caused by seepage of the conductive material into the electrode unit 120. It can be possible to adjust the HLB by changing the properties of inks made of the conductive materials or by modifying the surfaces of the electrode unit 120 in order to adjust the wetting and surface tension properties of the conductive material to be adequate for the electrode unit 120.

The leads 140 can be formed on the electrolyte membrane 110 in connection with the porous current collectors 130, and in such a manner, can electrically connect the multiple number of electrode units 120. By using the leads 140 to electrically connect the multiple electrode units 120 arranged on the same plane, it may not be necessary to use separate flexible substrates, etc., for electrically connecting the electrode units 120. Thus, the overall thickness can be reduced so that a fuel cell can be given a compact size, compared to the case of forming a fuel cell as a bipolar stack structure.

Here, instead of being formed on the electrolyte membrane 110, the leads 140 can be formed on a separate protective layer formed over the electrolyte membrane 110. For example, a gasket, etc., stacked over the electrolyte membrane 110 that surrounds the anodes 122 and cathodes 124 to prevent the supplied fuel and oxygen from leaking can be used as the protective layer.

Also, the lead 140 can be electrically connected with an anode 122 and a cathode 124 of different electrode units 120, such that a multiple number of electrode units 120 are electrically connected in series. That is, the electrode units 120 can be arranged in a lattice structure, etc., over both sides of the electrolyte membrane 110, where the electrode units 120 can be electrically connected in series, with the anode 122 of one electrode unit 120 connected by the lead 140 to the cathode 124 of another electrode unit 120.

By electrically connecting a multiple number of electrode units 120 in series using leads 140, the electrical power of the energy generated can be increased, making the cell unit 100 for a fuel cell applicable to electronic devices requiring higher-voltage. Here, there may not be any changes in thickness involved in increasing electrical power, so that the power output may be adjusted without being limited by the thickness.

Similar to the porous current collectors 130, the leads 140 may also be formed using an inkjet method, by coating a conductive material using an inkjet method over the electrolyte membrane 110 or over a protective layer, such as a gasket, etc., formed on the electrolyte membrane 110, and then curing and sintering the conductive material.

In this case, the leads 140 can be formed at the same time as when the porous current collectors 130 are formed using an inkjet method. Thus, similar to the case of the porous current collectors 130, the conductive material for forming the leads 140 can include gold particles of 100 nanometers or smaller, for example, and can be cured and sintered at a temperature of 100 to 1000 degrees Celsius, for example. Conductive carbon blacks are another example of conductive materials that may be used.

By using an inkjet method in forming the leads 140, the cell unit 100 for a fuel cell can be manufactured with higher levels of precision and with lower levels of cost. Also, by forming the leads 140 and the porous current collectors 130 simultaneously, such as by using programmable software for industrial print systems to control the output of ink onto different parts of the substrate, the manufacturing process can be simplified and manufacturing costs can be reduced. A description will now be provided on a method for manufacturing a cell unit for a fuel cell according to another aspect of the invention.

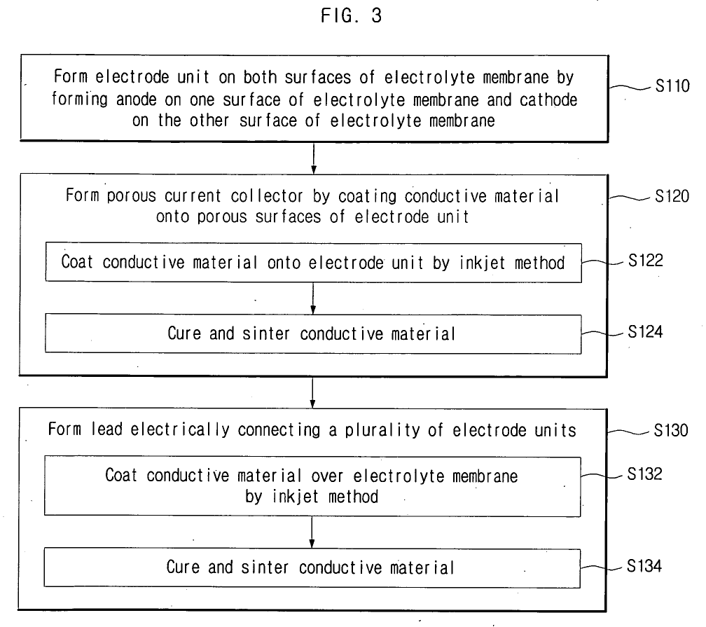

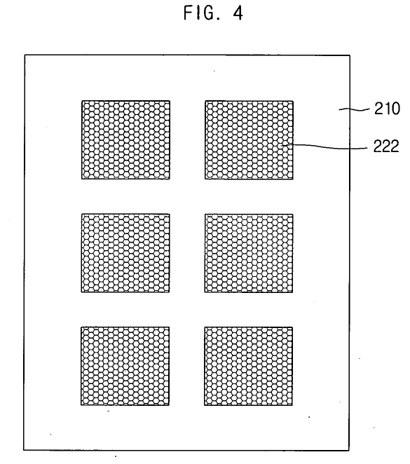

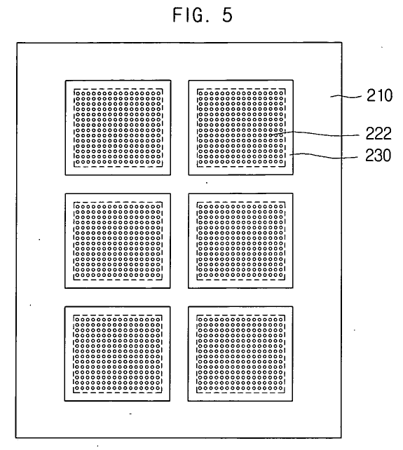

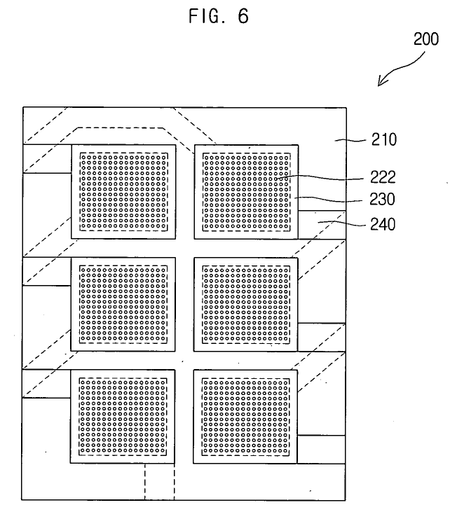

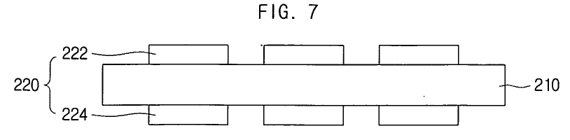

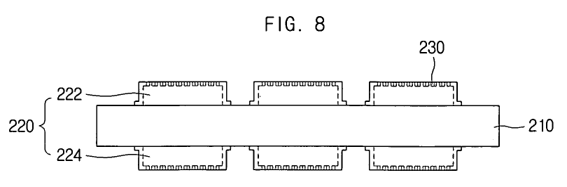

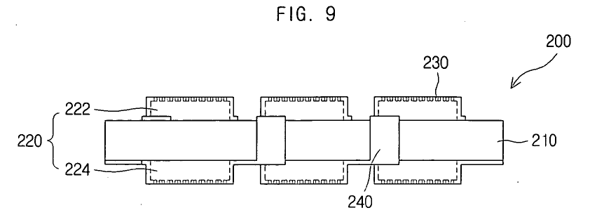

FIG. 3 is a flowchart illustrating a method of manufacturing a cell unit for a fuel cell according to an embodiment of the invention, FIG. 4 through FIG. 6 are plan views each representing a process in a method of manufacturing a cell unit for a fuel cell according to an embodiment of the invention, and FIG. 7 through FIG. 9 are side views each representing a process in a method of manufacturing a cell unit for a fuel cell according to an embodiment of the invention.

In FIG. 3 to FIG. 9, there are illustrated a cell unit 200 for a fuel cell, an electrolyte membrane 210, electrode units 220, anodes 222, cathodes 224, porous current collectors 230, and leads 240.

This embodiment of the present invention suggests a method for manufacturing the cell unit 200 for a fuel cell that can reduce the contact resistance between the electrode units 220 and the porous current collectors 230 by coating a conductive material onto the porous surfaces of the electrode unit 220 formed to include the anodes 222 and the cathodes 224 in order to form the porous current collectors 230 having micro-pores, thereby improving the efficiency of current collection for an identical area, in collecting electrons from the electrode units 220.

Forming the porous current collectors 230 directly onto the electrode units 220 by using an inkjet method can cause the porous current collectors 230 to be closely in intimate contact with the electrode units 220, accordingly, the contact resistance between the anodes 222 and cathodes 224 and the current collector layers 230 can be reduced, to thereby increase the current collection efficiency.

Moreover, leads 240 can be formed on the electrolyte membrane 210 to electrically connect a multiple number of electrode units 220 in series, so that it may not be necessary to use separate flexible substrates, etc., for electrically connecting the electrode units 220. Thus, the cell unit 200 for a fuel cell may be manufactured, which is applicable to electronic devices requiring higher-voltage.

As the leads 240 can be formed by using an inkjet method, and can be formed simultaneously with the process for forming the porous current collectors 230, the cell unit 200 for a fuel cell can be manufactured with higher levels of precision and lower levels of cost.

First, as illustrated in FIG. 4 and FIG. 7, the electrode units 230 can be formed on both surfaces of an electrolyte membrane 210 (S110). In particular, the anodes 222 can be formed on one surface of the electrolyte membrane 210, and the cathodes 224 can be formed on the other surface of the electrolyte membrane 210.

Here, the electrolyte membrane 210 can be interposed between the anodes 222 and the cathodes 224, and can allow transport of the hydrogen ions generated by the oxidation reactions at the anodes 222 to the cathodes 224. A polymer material can be used for the electrolyte membrane 210.

An electrode unit 220 can include an anode 222 and a cathode 224, where multiple electrode units 220 may be formed on the surface of the electrolyte membrane 210. The anodes 222 can be formed on one side of the electrolyte membrane 210, and can be supplied with a fuel, such as hydrogen. The fuel may undergo oxidation reactions at the catalyst layers of the anodes 222 to generate hydrogen ions and electrons. The cathodes 224 can be formed on the other side of the electrolyte membrane 210, and can be supplied with oxygen and the electrons generated at the anodes 222. Here the transported hydrogen ions, oxygen and electrons may undergo reduction reactions at the catalyst layers of the cathodes 224 to generate water molecules.

Such oxidation and reduction reactions can be utilized to obtain electrical energy directly from chemical energy. The chemical reactions at the anodes 222 and cathodes 224 can be represented by Reaction Scheme 1, as presented in the description above for the cell unit 100 for a fuel cell according to an embodiment of the invention.

Since multiple electrode units 220 can be formed over both sides of the electrolyte membrane 210, electrically connecting the electrode units 220 in series can provide a higher voltage without increasing the overall thickness as in the case of a bipolar stack structure. Leads 240 can be used to electrically connect the electrode units 220 in series. This will be described again in further detail in the description of the process for forming the leads 240.

Next, as illustrated in FIG. 5 and FIG. 8, porous current collectors 230 can be formed by coating a conductive material onto the porous surfaces of the electrode units 220 (S120). As described above, electrons can be generated by the oxidation reactions at the catalyst layers of the anodes 222. The electrons may pass through the gas diffusion layers of the anodes 222 to gather at the porous current collectors 230 and may travel through the leads 240 to the porous current collectors 230 of the cathodes 224, where they may pass through the gas diffusion layers of the cathodes 224 to catalyst layers of the cathodes 224 participate in the reduction reactions.

The porous current collectors 230 can be formed such as to gather electrons at the pores of the coated porous surfaces formed on the gas diffusion layers of the anodes 222 and cathodes 224. The porous current collectors 230 can be formed as follows.

First, a conductive material can be coated over the electrode units 220 by an inkjet method (S122). This can be performed by applying a thin coating of conductive material onto the porous surfaces of the electrode units 220 by use of an inkjet method, where the conductive material can be a material containing gold, and can include, for example, nanoparticles of 100 nanometers or smaller. Conductive carbon blacks are another example of conductive materials that may be used.

At this time, it may be required as described above to control the amount of conductive material coated onto the porous surfaces in order to adequately maintain the balance between the electrical conductivity of the porous current collectors 230 and the ability of fluids to flow properly throughout the electrode units 220. Moreover, it may be required to adjust the hydrophile-lipophile balance (HLB) between the conductive material and the electrode units 220 in order to prevent damage of the catalyst layer or the electrolyte membrane 210, caused by seepage of the conductive material into the electrode units 220.

Afterwards, the conductive material can be cured and sintered (S124). For example, the conductive material can be cured and sintered at 100 to 1000 degrees Celsius. This can cause the conductive material to be in intimate contact with the porous surfaces of the electrode units 220, thereby forming the porous current collectors 230 having micro-pores corresponding to the native pores of the porous surfaces, for example such as but not limited to those formed by the mesh structures of carbon cloth or woven carbon fibers, of the electrode units 220.

As such, as the porous current collectors 230 can be directly formed onto the electrode units 220 by using an inkjet method, the porous current collectors 230 can be made to adhere closely to the electrode units 220, and the contact resistance acting between the anodes 222 and cathodes 224 and the current collector layers 230 can be reduced. This can cause current collection efficiency to be increased.

In other words, as the porous current collectors 230 are directly formed onto the porous surfaces of the electrode units 220, it can be possible to reduce the contact resistance between the electrode units 220 and the porous current collectors 230. This can improve the efficiency of current collection for an identical area, in collecting electrons from the electrode units 220.

With the decrease in electrical contact resistance between electrode units 220 and porous current collectors 230 obtained by using the porous current collectors 230, it can be possible to reduce the thickness of end plates used without decreasing performance, as would be the case when electrode units and current collectors are not integrated

On the other hand, in accordance with the method for manufacturing the cell unit 200 for a fuel cell according to an embodiment of the present invention, the process represented by S110 in which the electrode units 220 are formed on the electrolyte membrane can be performed, and then the process represented by S120 in which the porous current collectors 230 are formed on the electrode units 220 can be performed. The method for manufacturing the cell unit 200 for a fuel cell, however, can be performed in another order. For example, after performing the process represented by S120 in which the porous current collectors 230 are formed on the electrode units 220, the process represented by S110 in which the electrode units 220 are formed on the electrolyte membrane can be performed. This reflects that the order of the processes is changed but the details of each process are not changed, and thus a detailed pertinent description is omitted as being redundant.

Next, as illustrated in FIG. 6 and FIG. 9, the leads 240 electrically connecting the electrode units 220 can be formed (S130). The leads 240 can be formed on the electrolyte membrane 210 in connection with the porous current collectors 230, and in such manner, can electrically connect the multiple electrode units 220. Similar to the porous current collectors 230, the leads 240 can be formed using an inkjet method. The process for forming the leads 240 can include the following procedures.

First, a conductive material can be coated over the electrolyte membrane 210 by an inkjet method (S132). That is, a conductive material can be coated on the electrolyte membrane 210 using an inkjet method. Here, instead of being formed on the electrolyte membrane 210, the leads 240 can be formed on a separate protective layer formed over the electrolyte membrane 210, such as a gasket, for example, stacked over the electrolyte membrane 210 to surround the anodes 222 and cathodes 224 and prevent the supplied fuel and oxygen from leaking.

Afterwards, the conductive material can be cured and sintered (S134). As the conductive material is cured and sintered, leads 240 can be formed that connect the porous current collectors 230.

Here, the leads 240 can be formed at the same time as when the porous current collectors 230 are formed using an inkjet method. Thus, similar to the case of the porous current collectors 230, the conductive material for forming the leads 240 can include gold particles of 100 nanometers or smaller, for example, and can be cured and sintered at a temperature of 100 to 1000 degrees Celsius, for example. Conductive carbon blacks are another example of conductive materials that may be used.

As the leads 240 can be formed by using an inkjet method, the cell unit 200 for a fuel cell can be manufactured with higher levels of precision and with lower levels of cost, and as the leads 240 and the porous current collectors 230 can be formed simultaneously, the manufacturing process can be simplified and manufacturing costs can be reduced.

As described above, a lead 240 can be electrically connected with an anode 222 and a cathode 224 of different electrode units 220, such that the electrode units 220 are electrically connected in series. That is, the electrode units 220 can be arranged in a lattice structure, etc., over both sides of the electrolyte membrane 210, where the electrode units 220 can be electrically connected in series, with the anode 222 of one electrode unit 220 connected by a lead 240 to the cathode 224 of another electrode unit 220.

By using the leads 240 to electrically connect multiple electrode units 220 arranged in the same plane, it may not be necessary to use a separate flexible substrate, etc., for electrically connecting the electrode units 220. Thus, the overall thickness can be reduced so that a fuel cell can be given a more compact size, compared to the case of forming a fuel cell as a bipolar stack structure.

Also, by electrically connecting the electrode units 220 in series using the leads 240, the electrical power of the energy generated can be increased, making the cell unit 200 for a fuel cell applicable to electronic devices requiring higher-voltages. There may not be any changes in thickness involved in increasing electrical power, so that the power output may be adjusted while being limited much less by the thickness.

Many embodiments other than those set forth above can be found in the appended claims.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A cell unit for a fuel cell comprising:
an electrolyte membrane;
an electrode unit including an anode and a cathode, the anode formed on one side of the electrolyte membrane, the cathode formed on the other side of the electrolyte membrane; and
a porous current collector being formed by coating a conductive material onto the porous surfaces of the electrode unit.

2. The cell unit for a fuel cell of claim 1, comprising a plurality of electrode units and further comprising a lead electrically connecting the plurality of electrode units.

3. The cell unit for a fuel cell of claim 2, wherein the lead electrically connects the plurality of electrode units in series.

4. A method of manufacturing a cell unit for a fuel cell, the method comprising:
forming an electrode unit on both surfaces of an electrolyte membrane by forming an anode on one surface of the electrolyte membrane and a cathode on the other surface of the electrolyte membrane; and
forming a porous current collector by coating a conductive material onto the porous surfaces of the electrode unit.

5. The method of claim 4, wherein forming the porous current collector comprises:
coating a conductive material onto the electrode unit by an inkjet method; and curing and sintering the conductive material.

6. The method of claim 4, wherein the electrolyte membrane has a plurality of electrode units formed thereon,
and the method further comprises, after forming the electrode unit:
forming a lead, the lead electrically connecting the plurality of electrode units.

7. The method of claim 6, wherein forming the lead comprises:
coating a conductive material over the electrolyte membrane by an inkjet method; and
curing and sintering the conductive material.

8. The method of claim 6, wherein forming the porous current collector and forming the lead are performed simultaneously.
